(19) United States
(12) Patent Application Publication
(10) Pub. No.: US 2026/0097629 A1
(43) Pub. Date: Apr. 9, 2026

(54) VEHICLE HAVING HVAC MODULE INCLUDING AN AIR GUIDE WITH INTEGRATED DUCTS

(71) Applicant: FCA US LLC, Auburn Hills, MI (US)

(72) Inventors: Prathap V. Krishnan, Chennai (IN); Anugraha Arumanayagam Jeevi, Chennai (IN); Miland R. Khedkar, Pune (IN); Anup S. Ninawe, Auburn Hills, MI (US); Sergio Garcia Weber, Cuajimalpa de Morelos (MX); Rohitashwa Kiran, Auburn Hills, MI (US)

(21) Appl. No.: 18/910,314

(22) Filed: Oct. 9, 2024

(51) Int. Cl. B60H 1/32; B62D 21/03

(52) U.S. Cl. CPC B60H 1/3227; B62D 21/03

(57) ABSTRACT

A vehicle including a pair of vehicle structural members positioned at a front of a vehicle body; at least one cross-bar member connecting the pair of vehicle structural members; and an HVAC module including a heat exchanger and an air guide assembly configured to direct ambient air from the front of the vehicle body toward the heat exchanger, wherein the air guide assembly includes a pair of side panels connected to a lower panel upon which the heat exchanger rests, the at least one cross-bar member at least partially obstructs air flow to the heat exchanger, and the lower panel includes at least one duct that directs air around the at least one cross-bar member to areas of the heat exchanger that are at least partially obstructed by the at least one cross-bar member.

### FIELD

The present disclosure relates to a vehicle having an HVAC module including an air guide with integrated ducts.

### BACKGROUND

This section provides background information related to the present disclosure which is not necessarily prior art.

Vehicles may include a heating, ventilation, and air conditioning (HVAC) system that may be used to heat and/or cool a cabin of the vehicle. The HVAC system includes heat exchangers such as a condenser and evaporator that each require air to pass therethrough to exchange heat with a heat exchange fluid flowing through the respective heat exchanger. In general, air may pass through a grille located at a front of the vehicle before passing through the respective heat exchanger. Various features such as air guides can be used to direct the air after it has passed through the grille in a direction toward the heat exchanger.

As vehicles and customers become more sophisticated, however, the performance targets of the heat exchangers have become more stringent. To achieve these more stringent performance targets, it is desirable that a sizable portion of the cold ambient air from outside the vehicle reach the respective heat exchanger in order to achieve optimum performance of the heat exchangers and the HVAC system as a whole. Moreover, as vehicles have become more sophisticated and include more features, it has become increasingly difficult to control the amount of air that can be directed to the heat exchanger because of obstructions that may occur due to the packaging restraints associated with incorporating the additional features into the vehicle, and because of obstructions that may occur as a result of more advanced chassis components being implemented that, while improving vehicle safety, may disrupt the flow path of air to the heat exchangers.

### SUMMARY

This section provides a general summary of the disclosure, and is not a comprehensive disclosure of its full scope or all of its features.

According to a first aspect of the present disclosure, there is provided a vehicle including a pair of vehicle structural members positioned at a front of a vehicle body; at least one cross-bar member connecting the pair of vehicle structural members; and an HVAC module including a heat exchanger and an air guide assembly configured to direct ambient air from the front of the vehicle body toward the heat exchanger, wherein the air guide assembly includes a pair of side panels connected to a lower panel upon which the heat exchanger rests, the at least one cross-bar member at least partially obstructs air flow to the heat exchanger, and the lower panel includes at least one duct that directs air around the at least one cross-bar member to areas of the heat exchanger that are at least partially obstructed by the at least one cross-bar member.

According to the first aspect, the lower panel includes a plurality of the ducts.

According to the first aspect, the lower panel includes a front section that is connected to a first downwardly extending section, a middle section connected to the first downwardly extending section, a second downwardly extending section connected to the middle section, and a rear section connected to the second downwardly extending section.

According to the first aspect, the front section includes at least one inlet and the second downwardly extending section includes at least one outlet, and the at least one duct extends between the at least one inlet and the at least one outlet.

According to the first aspect, the at least one duct includes an upper panel and a lower panel that are connected by a pair of side panels, the at least one duct including a first open end in communication with inlet and a second open end in communication with the outlet.

According to the first aspect, a size of the first open end is less than a size of the second open end.

According to the first aspect, a length of the first open end extends along over half of a length of the front section, and a length of the second open end extends along over half a length of the second downwardly extending section.

According to the first aspect, the pair of side panels each include an aperture configured for receipt of the at least one cross-bar member.

According to a second aspect of the present disclosure there is provided a vehicle including a pair of vehicle structural members positioned at a front of a vehicle body; at least one cross-bar member connecting the pair of vehicle structural members; and an HVAC module including a heat exchanger and an air guide assembly configured to direct ambient air from the front of the vehicle body toward the heat exchanger, wherein the air guide assembly includes a pair of side panels connected to a lower panel upon which the heat exchanger rests, the at least one cross-bar member at least partially obstructs air flow to the heat exchanger, and the lower panel includes a plurality of ducts that each direct air around the at least one cross-bar member to areas of the heat exchanger that are at least partially obstructed by the at least one cross-bar member.

According to the second aspect, the lower panel includes a front section that is connected to a first downwardly extending section, a middle section connected to the first downwardly extending section, a second downwardly extending section connected to the middle section, and a rear section connected to the second downwardly extending section.

According to the second aspect, the front section includes a plurality of inlets and the second downwardly extending section includes a plurality of outlets, and the ducts extend between a respective inlet and a respective outlet.

According to the second aspect, each of the ducts include an upper panel and a lower panel that are connected by a pair of side panels, and each duct includes a first open end in communication with respective inlet and a second open end in communication with the respective outlet.

According to the second aspect, a size of the first open end is less than a size of the second open end.

According to the second aspect, the pair of side panels each include an aperture configured for receipt of the at least one cross-bar member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a vehicle according to a principle of the present disclosure having an HVAC module including a heat exchanger;

FIG. 2 is a front isometric perspective view of an example HVAC module including an air guide having integrated ducts according to a principle of the present disclosure;

FIG. 3 is a bottom isometric perspective view of the example HVAC module including the air guide having the integrated ducts shown in FIG. 2;

FIG. 4 is a rear isometric perspective view of the example HVAC module including the air guide having the integrated ducts shown in FIG. 2;

FIG. 5 is an exploded perspective view of the example HVAC module illustrated in FIG. 2;

FIG. 6 is an isometric cross-sectional view of the example HVAC module including the air guide having the integrated ducts shown in FIG. 2;

FIG. 7 is a front isometric perspective view of another example HVAC module including an air guide having a single integrated duct according to a principle of the present disclosure; and

FIG. 8 is a bottom isometric perspective view of the example HVAC module including the air guide having the integrated duct shown in FIG. 7.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

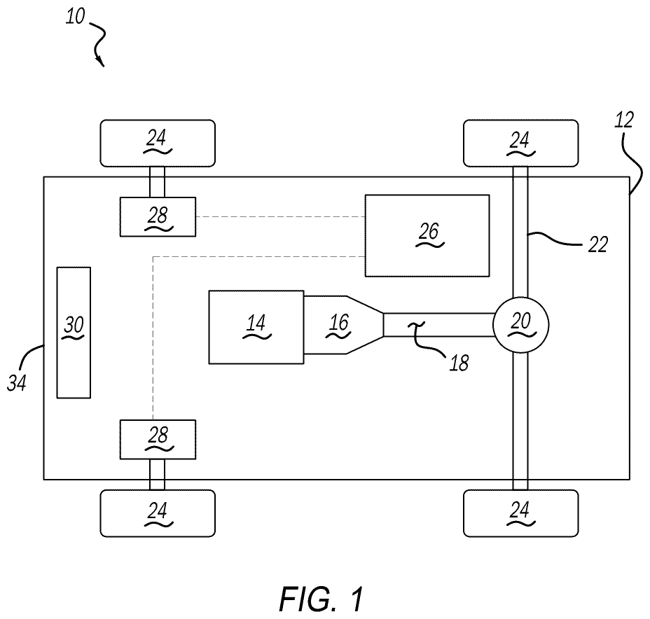

FIG. 1 illustrates a schematic example of a vehicle 10 according to a principle of the present disclosure. Vehicle 10 may include a body 12, an engine 14, transmission 16, drive shaft 18, rear differential 20, rear axle 22, and a plurality of wheels 24. Engine 14 may be an internal combustion engine (ICE). If vehicle 10 is a hybrid vehicle, vehicle 10 may also include a battery pack 26 having a plurality of battery cells (not shown) and at least one (in the illustrated embodiment, two) electric drive modules 28. While vehicle 10 is illustrated as being a hybrid vehicle including ICE 14 for driving rear wheels 24 and electric drive modules 28 for driving front wheels 24, it should be understood that vehicle 10 may only include ICE 14 or only include electric drive modules 28. That is, vehicle 10 may be a conventional ICE-powered vehicle or an entirely electric vehicle without departing from the scope of the present disclosure.

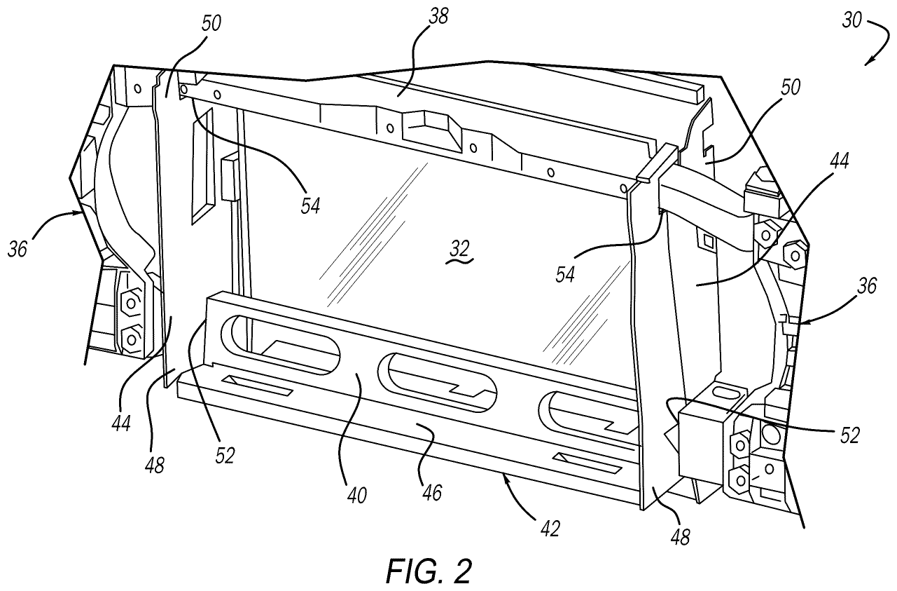

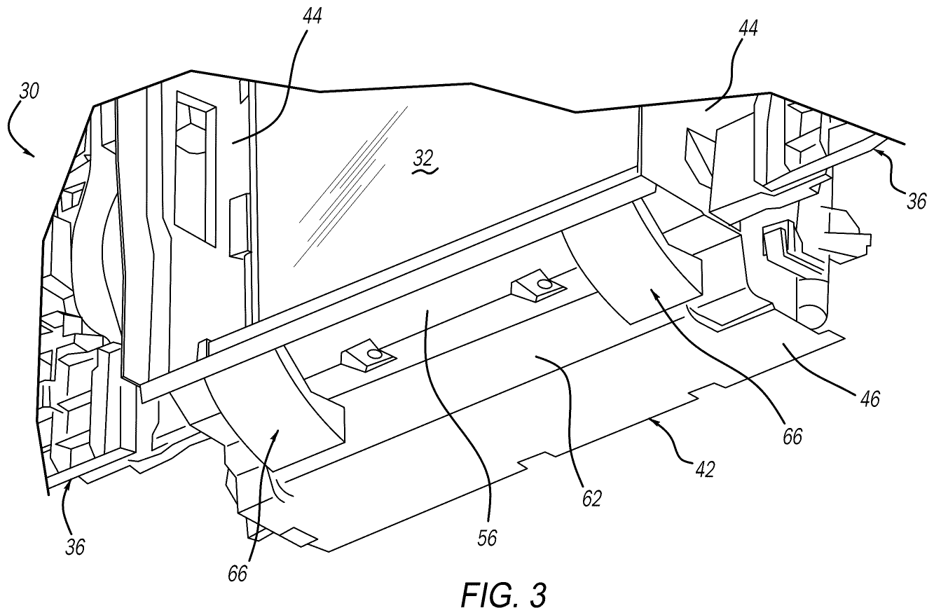

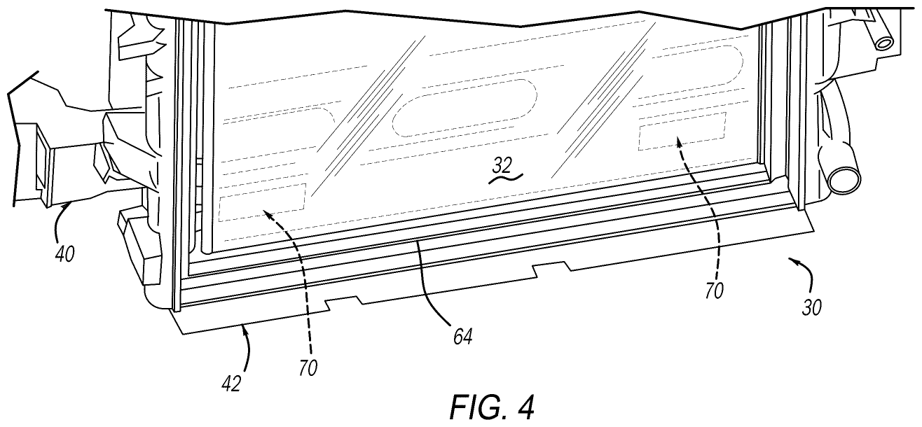

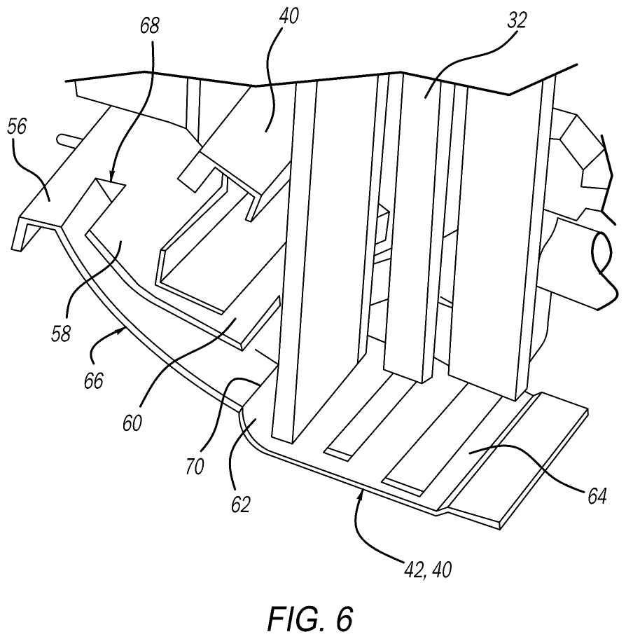

Regardless the type of propulsion system that is used to power vehicle 10, vehicle 10 also includes a HVAC module 30 that may include at least one heat exchanger 32 (FIGS. 2-8) that, in the illustrated embodiment, may be a condenser and is located at a front end 34 of vehicle 10. Referring to FIGS. 2-6, HVAC module 30 may be located proximate to and/or between a pair of vehicle structural or chassis members 36 that are connected to each other by an upper cross-bar member 38 and a lower cross-bar member 40. Chassis members 36 and upper and lower cross-bar members 38, 40 may be attached to a frame assembly (not shown) of vehicle 10, and are designed and configured to provide structural support to vehicle 10.

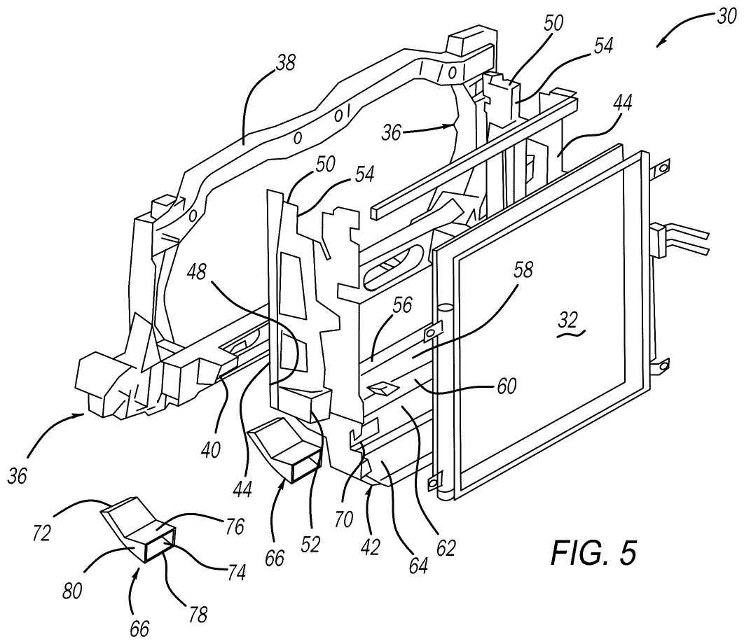

In addition to condenser 32, HVAC module 30 includes an air guide assembly 42 that is designed and configured to guide air received from an opening or grille (not shown) located at front end 34 of vehicle 10 toward condenser 32. As best shown in FIG. 5, air guide assembly 42 includes a pair of side panels 44 that are attached to a lower panel 46. Side panels 44 and lower panel 46 may be formed of a rigid material such as a rigid metal material (e.g., aluminum) or a rigid polymeric material (e.g., polyamide).

Side panels 44 each include a proximate end 48 that is attached to lower panel 46 and a distal end 50. A first aperture or cut-out 52 is located at proximate end 48 that is configured for receipt of lower cross-bar member 40 such that lower cross-bar member 40 passes in front of condenser 32 and provides protection to condenser 32 in the event that vehicle 10 is involved in a collision. A second aperture or cut-out 54 is located at distal end 50 that is configured for receipt of upper cross-bar member 38.

Still referring to FIG. 5, lower panel 46 is a tiered panel that includes a front section 56 that transitions to a first downwardly extending section 58. First downwardly extending section 58 is connected to and transitions into a middle section 60, which transitions to a second downwardly extending section 62. Second downwardly extending section 62 is connected and transitions to a rear section 64 upon which condenser 32 rests.

As noted above, lower cross-bar member 40 passes in front of condenser 32. As best shown in FIG. 2, lower cross-bar member 40 is located above front section 56. While lower cross-bar member 40 is beneficial for providing increased safety to occupants of vehicle 10 during a collision, and is beneficial for providing protection to condenser 32, one of the drawbacks to having lower cross-bar member 40 positioned forward of condenser 32 is that air flow received by air guide assembly 42 can be partially blocked by lower cross-bar member 40, which may cause “hot spots” to occur at condenser 32 that may not be as effective for heat exchange due to the air flow not impinging the condenser 32 at locations located behind lower cross-bar 40 to the same extent as other locations of condenser 32 that are not obstructed. Thus, to increase air flow to locations of condenser 32 that may be obstructed by lower cross-bar member 40, air guide assembly 42 includes at least one duct 66 that receives air from a location forward of lower cross-bar member and directs the air to locations of condenser that may be obstructed.

More specifically, as best shown in FIGS. 2-6, front section 56 includes at least one (in the illustrated embodiment two) inlet 68, which is a first through-hole that is formed in front section 56. Further, second downwardly extending section 62 includes at least one (in the illustrated embodiment, two) outlet 70, which is a second through-holed forward in second downwardly extending section 62. Duct 66 includes an open first end 72 that is attached to an underside of front section 56 at inlet 68 and an open second end 74 that is attached to a second downwardly extending section 62 at outlet 70. Similar to side panels 44 and lower panel 46, duct 66 may be formed of either a rigid metal material or a rigid polymeric material. Duct 66 may be attached to front section 56 and second downwardly extending section 62 using an adhesive (not shown), a fastener (not shown), welding, brazing, or any other attachment method known to one skilled in the art.

Duct 66 may include an upper wall 76, a lower wall 78, and a pair of sidewalls 80 that connect upper wall 76 to lower wall 78. As best shown in FIG. 5, the open first end 72 may be smaller in size in comparison to open second end 74. With such a configuration, air that enters inlet 68 will accelerate in velocity before exiting outlet 70 towards condenser 32. It should be understood, however, that a size of open first end 72 may be the same as that of open second end 74, or may be larger than that of open second end 74, without departing from the scope of the present disclosure. The primary aspect to keep in mind is that air is drawn into duct 66 and directed toward a lower end of condenser 32 to provide an increased amount of air to the lower end of condenser 32 to increase the effectiveness of heat exchange at the lower end of condenser 32.

Further, while only a pair of ducts 66 are illustrated in FIGS. 2-7, it should be understood that a greater number of ducts 66 can be used if designed. For example, a third duct 66 may be located between the pair of ducts 66 shown. The primary reason ducts 66 are located at opposing ends of air guide assembly 42 is that the lower corners of condenser 32 have been found to receive less cold ambient air in comparison to other locations of condenser 32. Nonetheless, the “hot spots” of condenser 32 may be determined using computational flow dynamics (CFD) testing or some other type of testing (e.g., physical testing) and air guide assembly 42 can be designed or modified based on this testing accordingly. It should also be understood that the use of duct(s) 66 also may assist in avoiding recirculation of warm air in front of the HVAC module 30.

In another aspect of the present disclosure, it should also be understood that the use of duct 66 enables existing air guide assemblies 42 to be modified to include duct 66. That is, an existing air guide assembly 42 can be modified to include at least one inlet 68 and at least one outlet 70 and duct 66 can be attached between inlet 68 and outlet 70. Put another way, a design of an entirely new air guide assembly 42 can be avoided and existing air guide assemblies may be able to be retrofitted with duct 66 to improve performance of condenser 32.

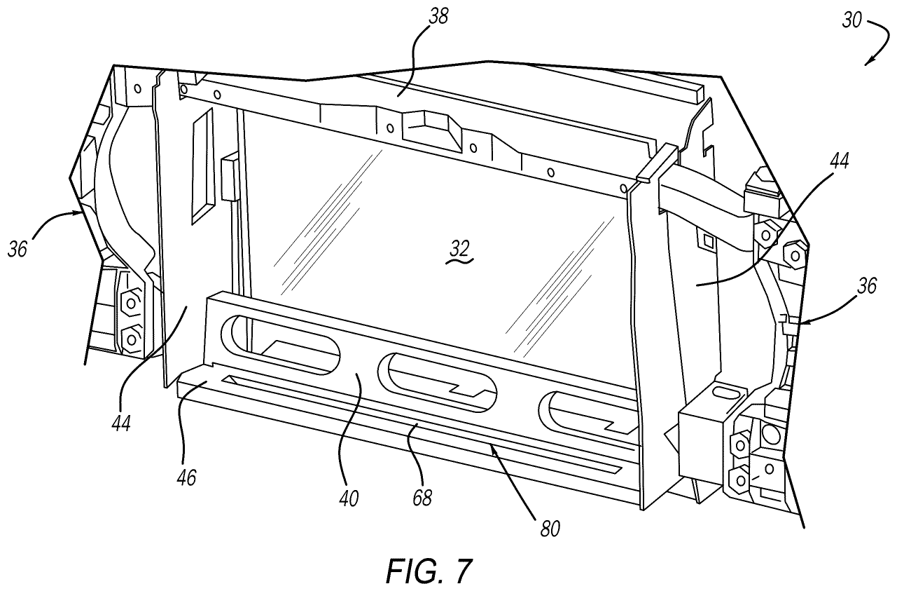

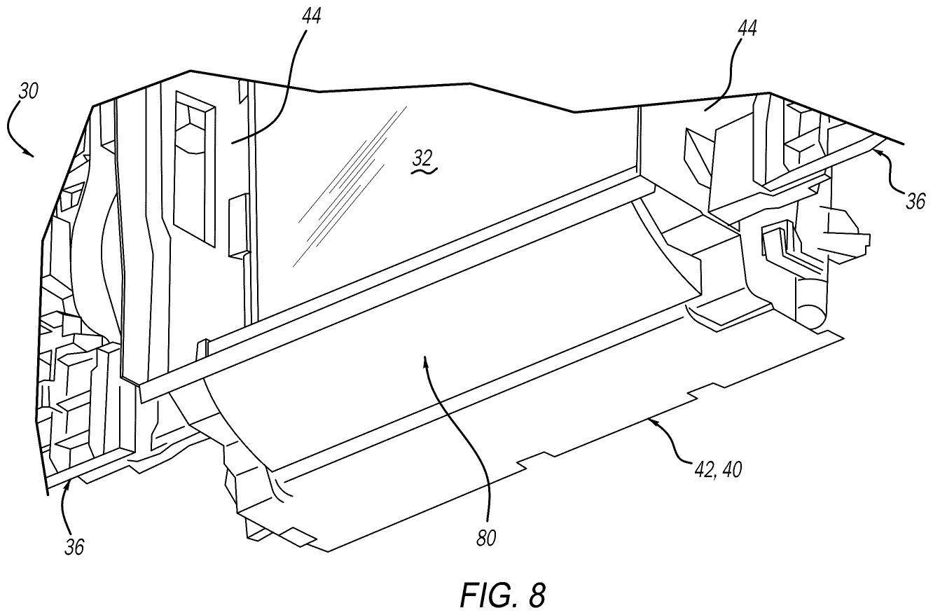

Now referring to FIGS. 7 and 8, a second embodiment of the present disclosure is illustrated. The configuration shown in FIGS. 7 and 8 is substantially similar to that shown in FIGS. 2-6, but HVAC module 30 only includes a single duct 80 that is much larger in size in comparison to the ducts 66 shown in the previous embodiment. In this regard, front section 56 includes an inlet 68 that extends along substantially the entire length L1 (i.e., a length of the inlet and first open end of duct 80 is greater than half the length L1) of front section 56, and second downwardly extending section 62 includes an outlet 70 that extends along substantially the entire length L2 (i.e., a length of the outlet and second open end of duct 80 is greater than half the length L2) of second downwardly extending section 62. The use of such a single duct 80 enables an increased amount of cold ambient air to reach substantially the entire lower portion of condenser 32 rather than simply the lower corners of condenser 32.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle, comprising:
a pair of vehicle structural members positioned at a front of a vehicle body;
at least one cross-bar member connecting the pair of vehicle structural members; and
an HVAC module including a heat exchanger and an air guide assembly configured to direct ambient air from the front of the vehicle body toward the heat exchanger,
wherein the air guide assembly includes a pair of side panels connected to a lower panel upon which the heat exchanger rests,
the at least one cross-bar member at least partially obstructs air flow to the heat exchanger, and
the lower panel includes at least one duct that directs air around the at least one cross-bar member to areas of the heat exchanger that are at least partially obstructed by the at least one cross-bar member.

2. The vehicle according to claim 1, wherein the lower panel includes a plurality of the ducts.

3. The vehicle according to claim 1, wherein the lower panel includes a front section that is connected to a first downwardly extending section, a middle section connected to the first downwardly extending section, a second downwardly extending section connected to the middle section, and a rear section connected to the second downwardly extending section.

4. The vehicle according to claim 3, wherein the front section includes at least one inlet and the second downwardly extending section includes at least one outlet, and the at least one duct extends between the at least one inlet and the at least one outlet.

5. The vehicle according to claim 4, wherein the at least one duct includes an upper panel and a lower panel that are connected by a pair of side panels, the at least one duct including a first open end in communication with inlet and a second open end in communication with the outlet.

6. The vehicle according to claim 5, wherein a size of the first open end is less than a size of the second open end.

7. The vehicle according to claim 1, wherein a length of the first open end extends along over half of a length of the front section, and a length of the second open end extends along over half a length of the second downwardly extending section.

8. The vehicle according to claim 1, wherein the pair of side panels each include an aperture configured for receipt of the at least one cross-bar member.

9. A vehicle, comprising:
a pair of vehicle structural members positioned at a front of a vehicle body;
at least one cross-bar member connecting the pair of vehicle structural members; and
an HVAC module including a heat exchanger and an air guide assembly configured to direct ambient air from the front of the vehicle body toward the heat exchanger,
wherein the air guide assembly includes a pair of side panels connected to a lower panel upon which the heat exchanger rests,
the at least one cross-bar member at least partially obstructs air flow to the heat exchanger, and
the lower panel includes a plurality of ducts that each direct air around the at least one cross-bar member to areas of the heat exchanger that are at least partially obstructed by the at least one cross-bar member.

10. The vehicle according to claim 9, wherein the lower panel includes a front section that is connected to a first downwardly extending section, a middle section connected to the first downwardly extending section, a second downwardly extending section connected to the middle section, and a rear section connected to the second downwardly extending section.

11. The vehicle according to claim 10, wherein the front section includes a plurality of inlets and the second downwardly extending section includes a plurality of outlets, and the ducts extend between a respective inlet and a respective outlet.

12. The vehicle according to claim 11, wherein each of the ducts include an upper panel and a lower panel that are connected by a pair of side panels, and each duct includes a first open end in communication with respective inlet and a second open end in communication with the respective outlet.

13. The vehicle according to claim 12, wherein a size of the first open end is less than a size of the second open end.

14. The vehicle according to claim 9, wherein the pair of side panels each include an aperture configured for receipt of the at least one cross-bar member.
